(19) United States
(12) Patent Application Publication
(10) Pub. No.: US 2018/0056251 A1
(43) Pub. Date: Mar. 1, 2018

(54) STACKABLE STATIC MIXING ELEMENTS

(71) Applicant: Ryan R. Hopkins, Reno, NV (US)

(72) Inventor: Ryan R. Hopkins, Reno, NV (US)

(73) Assignee: Moldman Systems LLC, Reno, NV (US)

(21) Appl. No.: 15/251,931

(22) Filed: Aug. 30, 2016

(51) Int. Cl. B01F 5/06

(52) U.S. Cl. CPC B01F 5/0615; B01F 2005/0635; B01F 2005/0629

(57) ABSTRACT

A static mixer is provided. The static mixer includes a plurality of static mixer elements. Each static mixer element includes a core extending axially along a longitudinal axis between a first end and a second end. Each static mixer element includes at least one blade around an outside of the core. At least a first one of the plurality of static mixer elements includes a first keying feature. At least a second one of the plurality of static mixer elements including a second keying feature configured to engage the first keying feature to prevent relative rotation between the first one of the plurality of static mixer elements and the second one of the plurality of static mixer elements about the longitudinal axes of the first one and the second one of the plurality of static mixer elements. Methods of forming the static mixer are also provided.

### FIELD OF THE INVENTION

This invention generally relates to mixing of multiple materials to form multi-part materials and more particularly to static mixers for mixing the material such as in a material dispenser or mold arrangement.

### BACKGROUND OF THE INVENTION

Static mixers can be used to mix a plurality of different materials to form a mixed material that can then be used for various activities. For instance, the mixed material could be used in a molding system for molding desired components. Alternatively, the material could be dispensed directly into other components such as a multi-part material.

Unfortunately, static mixer elements of static mixers are often manufactured in set lengths. This limits the end user to working with static mixer elements that may not be the most ideal for a desired application. Working with long static mixer element increases the amount of material wasted when the material begins to cure within the static mixer. Static mixer elements that are too short do not thoroughly mix the material.

Further, static mixers can have relatively complex blade and core configurations making it expensive to produce the molds for forming lengthy static mixers. A static mixer is typically formed from a plurality of portions. The portions are often substantially identical to one another, but adjacent portions are angularly offset to force mixer of the material as it flows through the static mixer. Thus, a mold made to form an entire static mixer element has a lot of repeated sections which can make the tooling unnecessarily costly.

Embodiments disclosed herein relate to improvements in static mixers and particularly methods in forming static mixers to be more adaptable as well as to be more cost effectively manufactured.

### BRIEF SUMMARY OF THE INVENTION

Embodiments of the invention provide a new and improved static mixer and methods of forming the static mixer. More particularly, embodiments of the invention provide a new and improved static mixer formed from a plurality of stacked static mixer elements. Methods of forming the static mixer are also provided.

In a particular embodiment, a static mixer is provided. The static mixer includes a plurality of static mixer elements. Each static mixer element includes a core extending axially along a longitudinal axis between a first end and a second end. Each static mixer element includes at least one blade around an outside of the core. At least a first one of the plurality of static mixer elements includes a first keying feature. At least a second one of the plurality of static mixer elements including a second keying feature configured to engage the first keying feature to prevent relative rotation between the first one of the plurality of static mixer elements and the second one of the plurality of static mixer elements about the longitudinal axes of the first one and the second one of the plurality of static mixer elements.

In one embodiment, the first keying feature is provided by at least two projections extending axially parallel to the longitudinal axes of the first one of the plurality of static mixer elements and the second keying features is provided by corresponding at least two receiving pockets extending axially parallel to the longitudinal axes of the second one of the plurality of static mixer elements.

In one embodiment, the at least two projections extend axially from an the first end of the core of the first one of the plurality of static mixer elements and the at least two receiving pockets extend axially into the second end of the core of the second one of the plurality of static mixer elements.

In one embodiment, the core of each static mixer element is hollow to permit receipt of a shut-off pin to extend therethrough.

In one embodiment, the core of each static mixer element is solid.

In one embodiment, the first keying feature is provided at the first end of the core of the first one of the plurality of static mixer elements and the second keying feature is provided at the second end of the core of the second one of the plurality of static mixer elements. The first end of the first one of the plurality of static mixer elements is axially adjacent the second end of the second one of the plurality of static mixer elements when the first keying feature is engaged with the second keying feature. The at least one blade of each static mixer element has a first blade end proximate the first end of the core and a second blade end proximate the second end of the core. The at least one blade of each static mixer element extends helically around the core of the static mixer element between the first and second blade ends. The first and second keying features are configured such that the first blade end of the at least one blade of the first one of the plurality of static mixer elements is angularly offset from the second blade end of the at least one blade of the second one of the plurality of static mixer elements such that the blades of the first and second ones of the plurality of static mixer elements due not align to form a continuous blade.

In one embodiment, each static mixer element includes at least two blades extending axially along the core and helically around the core. Adjacent blade ends of the first and second ones of the plurality of static mixer elements are angularly offset such that the blade ends of the at least two blades of the first one of the plurality of static mixer elements do not align with the blade ends of the at least two blades of the second one of the plurality of static mixer elements such that the at least two blades of the first and second ones of the plurality of static mixer elements do not form continuous blades.

In one embodiment, the first blade ends of the at least two blades of the first one of the plurality of static mixer elements are angularly offset from one another by 180 degrees and the second blade ends of the at least two blades of the second one of the plurality of static mixer elements are angularly offset from one another by 180 degrees. The first blade ends of first one of the plurality of static mixer elements are 90 degrees offset from the second blade ends of the second one of the plurality of static mixer elements when the first and second ones of the plurality of static mixer elements are engaged.

In on embodiment, the at least one blade of the first one of the plurality of static mixer elements extends angularly about the core of the first one of the plurality of static mixer elements in a first direction from the first end to the second end and the at least one blade of the second one of the plurality of static mixer elements extends angularly about the core of the second one of the plurality of static mixer elements in a second angular direction from the first end to the second end, the second direction being opposite the first direction.

In on embodiment, the plurality of static mixer elements includes a third one of the plurality of static mixer elements that is substantially identical to the first one of the plurality of static mixer elements. The plurality of static mixer elements includes a fourth one of the plurality of static mixer elements that is substantially identical to the second one of the plurality of static mixer elements. The first, second, third and fourths ones of the plurality of static mixer elements re stacked with the second one of the plurality of static mixer elements between the first and third ones of the plurality of static mixer elements. The third one of the plurality of static mixer elements is stacked between the second and fourth ones of the plurality of static mixer elements.

Methods of forming the static mixers identified above are provided. A particular method includes producing a plurality of static mixer elements. Each static mixer element includes a core extending axially along a longitudinal axis between a first end and a second end. Each static mixer element including at least one blade around an outside of the core. At least a first one of the plurality of static mixer elements includes a first keying feature and at least a second one of the plurality of static mixer elements includes a second keying feature. The method includes engaging the first and second keying features to prevent relative rotation between the first one of the plurality of static mixer elements and the second one of the plurality of static mixer elements about the longitudinal axes of the first one and the second one of the plurality of static mixer elements.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic illustration of a multi-material dispensing system;

FIG. 2 is an illustration of a static mixer assembly for use in the system of FIG. 1;

FIG. 3 is a cross-sectional illustration of a dispensing and mixing unit of the system of FIG. 1;

FIG. 4 is a cross-sectional illustration of the static mixer assembly of FIG. 2;

FIG. 5 is a simplified partial illustration of the static mixer for use in the static mixer assembly of FIGS. 2 and 4;

FIG. 6 is a simplified exploded illustration of FIG. 5;

FIGS. 7 and 8 are perspective illustrations of a first one of the static mixer elements of the static mixer of FIG. 5;

FIGS. 9 and 10 are perspective illustrations of a second one of the static mixer elements of the static mixer of FIG. 5;

FIG. 11 is a simplified partial illustration of the static mixer for use in a static mixer assembly;

FIG. 12 is a simplified exploded illustration of FIG. 11;

FIGS. 13 and 14 are perspective illustrations of a first one of the static mixer elements of the static mixer of FIG. 11;

FIGS. 15 and 16 are perspective illustrations of a second one of the static mixer elements of the static mixer of FIG. 11; and

FIG. 17 is a further embodiment of a static mixer element for use in a static mixer.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

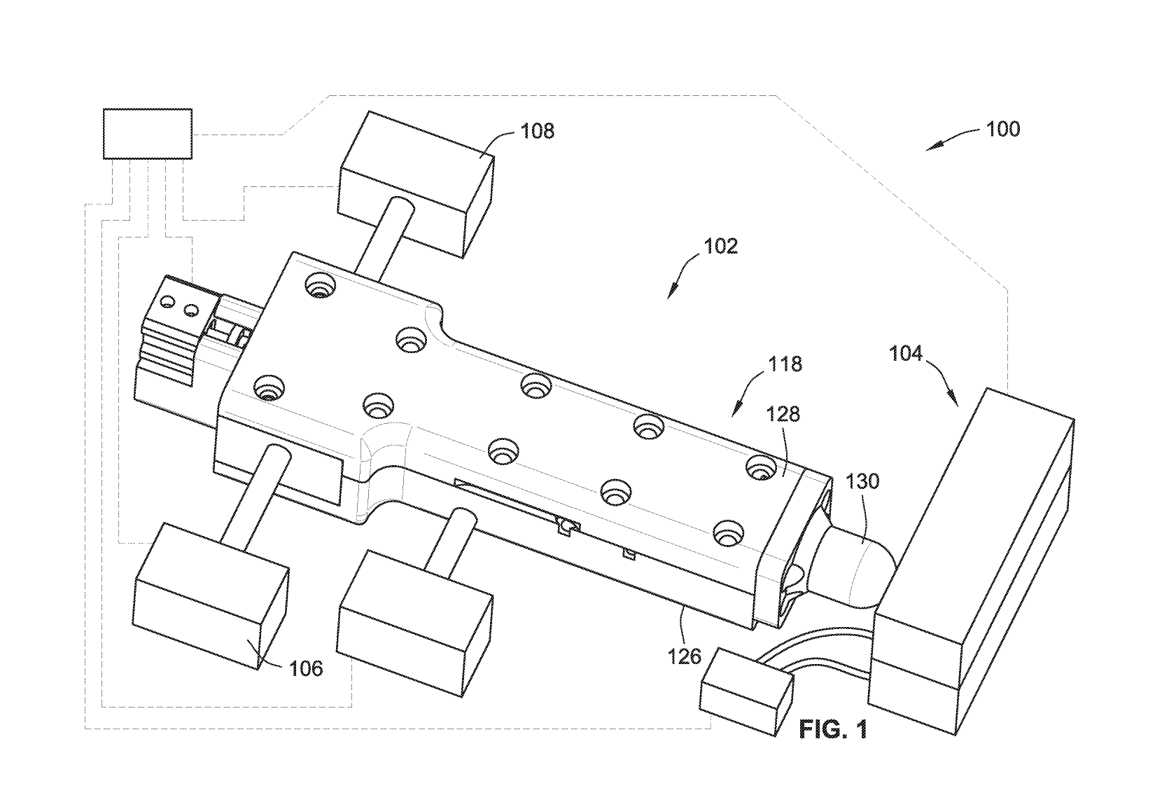

FIG. 1 illustrates a mix on demand, multi-material dispensing system according to an embodiment of the present invention. In this embodiment, the multi-material dispensing system is a molding machine 100. The molding machine 100 is configured to mold parts from a mixed material formed from a combination of a first material mixed with a second material. While this embodiment will be described with reference to a molding machine, the features thereof can be incorporated into other systems such as systems that do not use molds but simply dispenses the mixed material, where not contradicted by the disclosure.

The molding machine 100 generally includes a dispensing and mixing unit 102 that supplies material to a mold in the form of mold set 104 where the material dispensed from the dispensing and mixing unit 102 is formed into a predetermined shape defined by a mold cavity of the mold set 104. While referred to herein as a mold set, the mold set may also be referred to simply as a “mold” or as a “tool.” Details of the molding machine 100 and alternative implementations are disclosed in co-pending U.S. Provisional Patent Application Ser. No. 62/301,324 filed on Feb. 29, 2016, entitled MECHANISMS AND METHODS FOR MIXING AND/OR DISPENSING MULTI-PART MATERIALS, assigned to the instant assignee of the present application, the teachings and disclosure of which are incorporated herein by reference thereto.

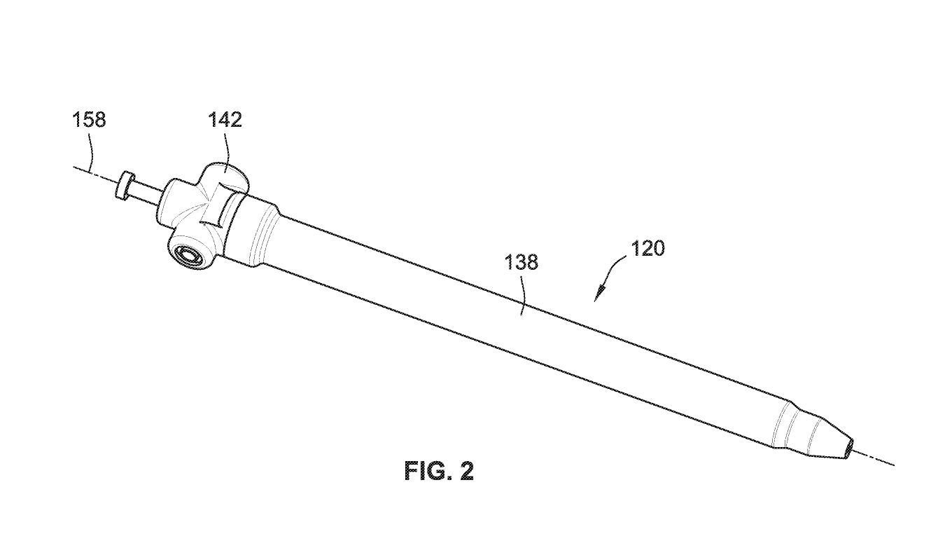

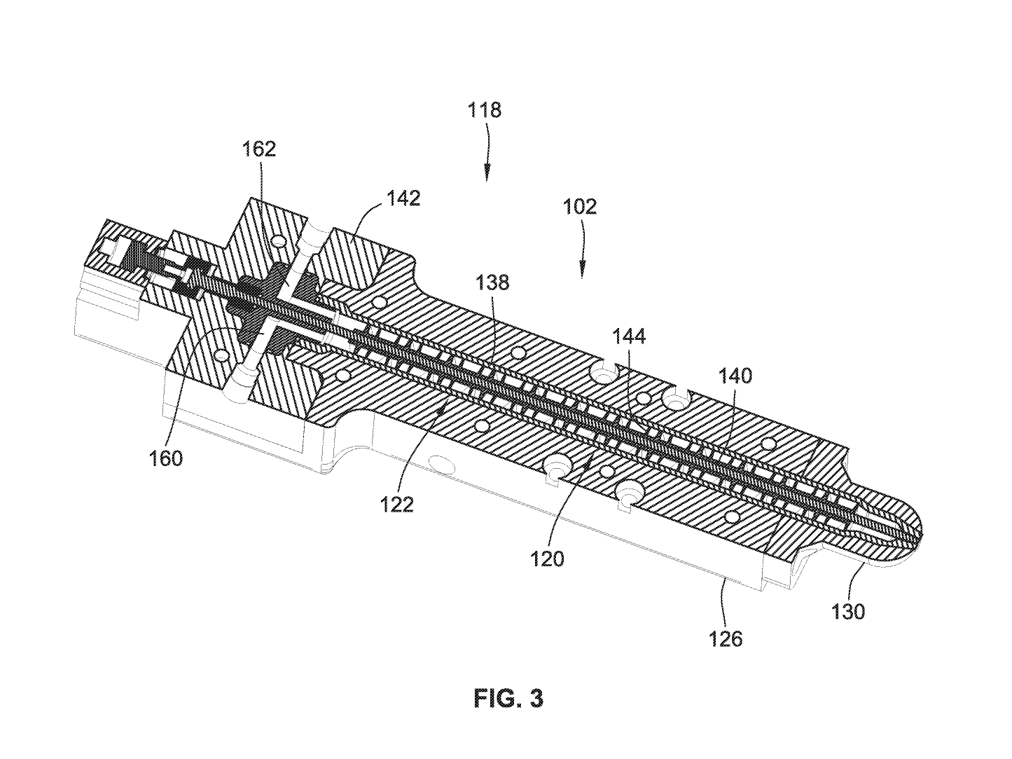

The dispensing and mixing unit 102 includes a static mixer holding arrangement 118 for holding a static mixer assembly 120 (see FIG. 2) in a static mixer holding cavity 122 (see FIG. 3). More particularly, the static mixer assembly 120 is mounted in the static mixer holding cavity 122 of the static mixer holding arrangement 118. The static mixer holding arrangement 118 and the static mixer assembly 120 are generally mating components such that the static mixer holding arrangement 118 provides pressure reinforcement of the static mixer assembly 120 such that high pressures can be used to force material through the static mixer assembly 120 without bursting the static mixer assembly 120. This is particularly useful to allow the system to process both low viscosity and high viscosity materials. In some embodiments, the static mixer holding arrangement can support the static mixer assembly 120 such that working pressures between 0 to 10,000 psi can be accommodated.

With primary reference to FIG. 3, the static mixer holding arrangement 118 includes first and second holding body portions 126, 128 that are operably connected to one another and a nozzle 130 operably connected to the first and second holding body portions 126, 128. The first and second holding body portions 126, 128 and the nozzle are removably connected to one another such that the static mixer holding cavity 122 defined thereby can be accessed for removal of the static mixer assembly 120 housed therein. These components are typically connected using bolts or screws.

The static mixer holding cavity 122 is generally shaped and sized to closely conform to the shape and size of the static mixer assembly 120 so as to provide structural support to the static mixer assembly 120. The structural support helps support the static mixer assembly 120 from the pressure of the first and second source of materials 106, 108 for supplying the first and second materials to dispensing and mixing unit 102. Further, a close mating relationship between the static mixer assembly 120 and the static mixer holding arrangement 118 improves heat transfer between the static mixer holding arrangement 118 and the static mixer assembly 120 when such heat transfer is desired.

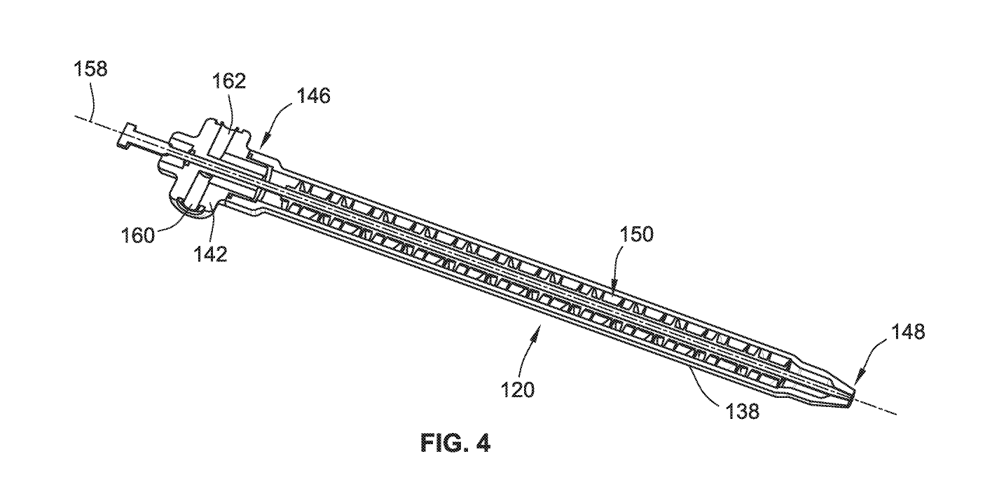

With reference to FIGS. 2-4, a first embodiment of the static mixer assembly 120 is illustrated. The static mixer assembly 120 generally includes the mixer housing tube 138, a shut-off pin 140, a material manifold 142 and a mixing element in the form of a static mixer 144.

The mixer housing tube 138 extends axially between an inlet end and an outlet end. The mixer housing tube 138 defines an internal cavity 150 generally extending between the inlet and outlet ends 146, 148. The outlet end 148 of the mixer housing tube 138 includes an outlet port 152. The outlet port 152 defines a sealing surface 154. The sealing surface 154 is a radially inner surface. The sealing surface 154 selectively cooperates with an outer surface of the distal end 156 of the shut-off pin 140 to selectively allow or prevent fluid flow through the outlet port 152. The outlet port 152, when not closed by shut-off pin 140, allows fluid to exit the internal cavity 150 and external of the static mixer assembly 120. While illustrated as a single piece, the mixer housing tube 138 could be formed from multiple components such that the internal cavity 150 is formed in part by more than one component that forms the mixer housing tube.

The shut-off pin 140 is located, at least in part, within the mixer housing tube 138 and particularly within the internal cavity 150 thereof. The shut-off pin 140 is selectively axially movable along a longitudinal axis 158 between an open position and a closed position.

The material manifold 142 is located proximate the inlet end 146 of the mixer housing tube 138. While illustrated as separate components, in other embodiments, the mixer housing tube 138 and material manifold 142 could be provided by a single component. In the illustrated embodiment, the inlet end 146 of the mixer housing tube 138 is sealingly coupled to the material manifold 142 such as by way of an O-ring or other gasket.

In the illustrated embodiment, the material manifold 142 defines first and second material inlets 160, 162. The first and second material inlets 160, 162 are operably coupled to the first and second source of materials 106, 108 in operation. The first and second material inlets 160, 162 are in fluid communication with the internal cavity 150 of the mixer housing tube 138. The internal cavity 150 fluidly communicates the first and second material inlets 160, 162 ultimately with the outlet port 152. While two inlets 160, 162 are illustrated, other embodiments could incorporate more than two inlets such that more than two materials can be mixed.

Typically, the first and second sources of material 106, 108 are coupled to the inlets 160, 162 by hoses that have couplings that sealingly mate with the material manifold 142. As the supplied first and second materials are under pressure, a mechanical connection preventing disconnection is desired. For instance, the couplings can threadedly engage the material manifold 142 or threadedly engage static mixer holding arrangement 118, such as first holding body portion 126. An O-ring, or other gasket, can be provided between the material manifold 142 and the hoses/couplings to prevent fluid leakage.

The static mixer 144 is located within the internal cavity 150 of the mixer housing tube 138. The static mixer 144 is located between the outlet port 152 and the material manifold 142 and particularly the first and second inlets 160, 162. The static mixer 144 includes a plurality of components for causing mixing of the first and second materials that enter through the first and second material inlets 160, 162. For example, the static mixer 144 includes a plurality of blades for causing intermixing of the two separate materials to form the mixed material that is ultimately dispensed. The static mixer 144 will form a mixing passage that will form, at least in part, a mixing passage that operably connects the first and second material inlets 160, 162 with the outlet port 152.

In the illustrated embodiment, the shut-off pin 140 extends axially along the longitudinal axis 158. The shut-off pin 140 is housed within a central cavity of a core of the static mixer 144 and extends through and moves relative to the static mixer 144 in the illustrated embodiment. However, in alternative embodiments, the static mixer and shut-off pin could be formed as a single unit such that oscillation of the shut-off pin between open and closed positions also oscillates the static mixer.

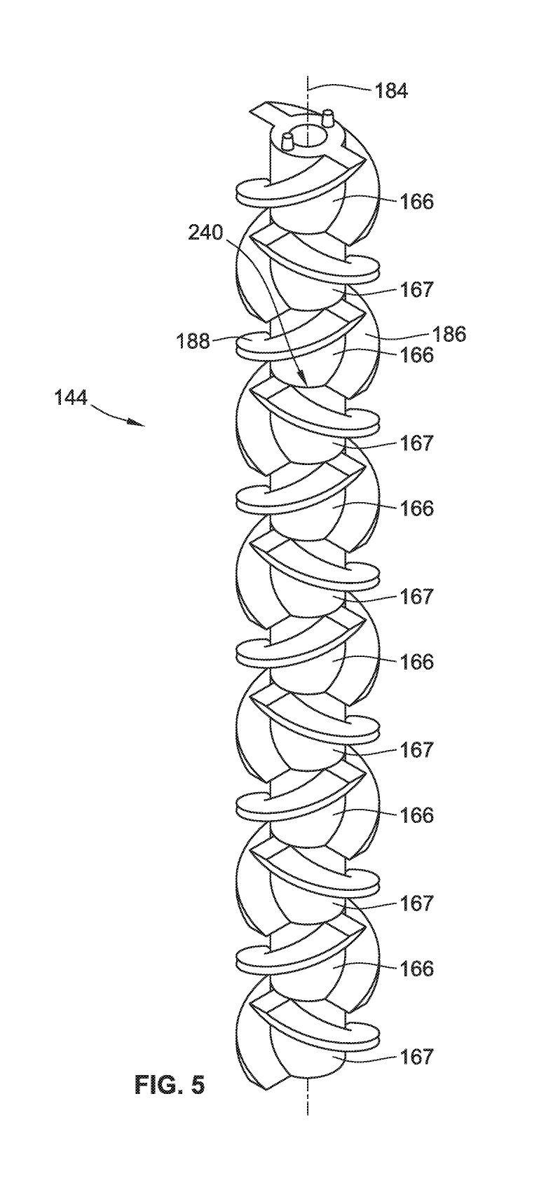

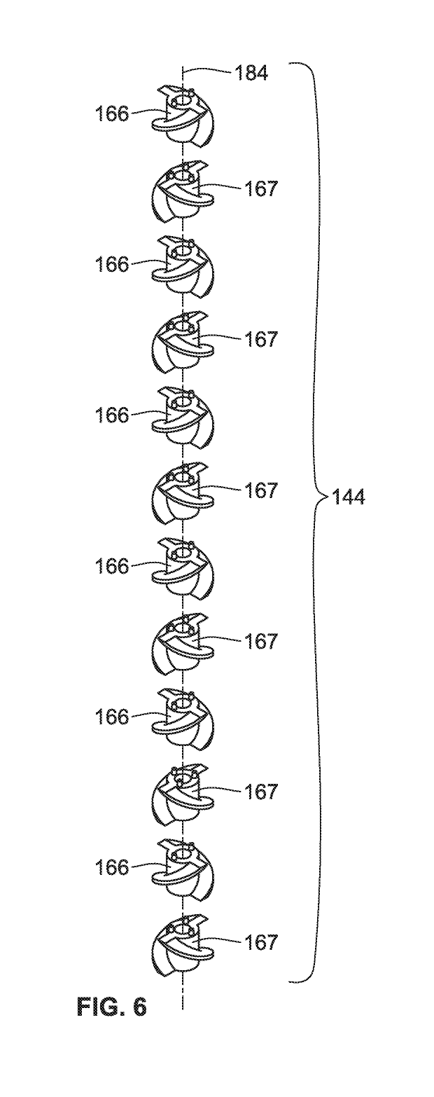

With reference to FIGS. 5 and 6, it is a feature of an embodiment of the static mixer 144 that the static mixer 144 is formed from a plurality of static mixer elements 166, 167 stacked together. This allows static mixers 144 of different lengths L to be easily manufactured by selecting the number of static mixer elements 166, 167 to stack to form the static mixer element 144. For instance, a user can stack a first number of static mixer elements 166, 167 to form a static mixer 144 of a first length and then stack a second number of static mixer elements 166, 167 different than the first number to form a static mixer 144 of a second length different than the first length.

Further, the static mixer 144 is formed from static mixer elements 166, 167 that have different orientations. The first static mixer element 166 directs fluid flowing through the static mixer 144 in a first direction while the second static mixer element 16 directs fluid flowing through the static mixer in a second, opposite direction.

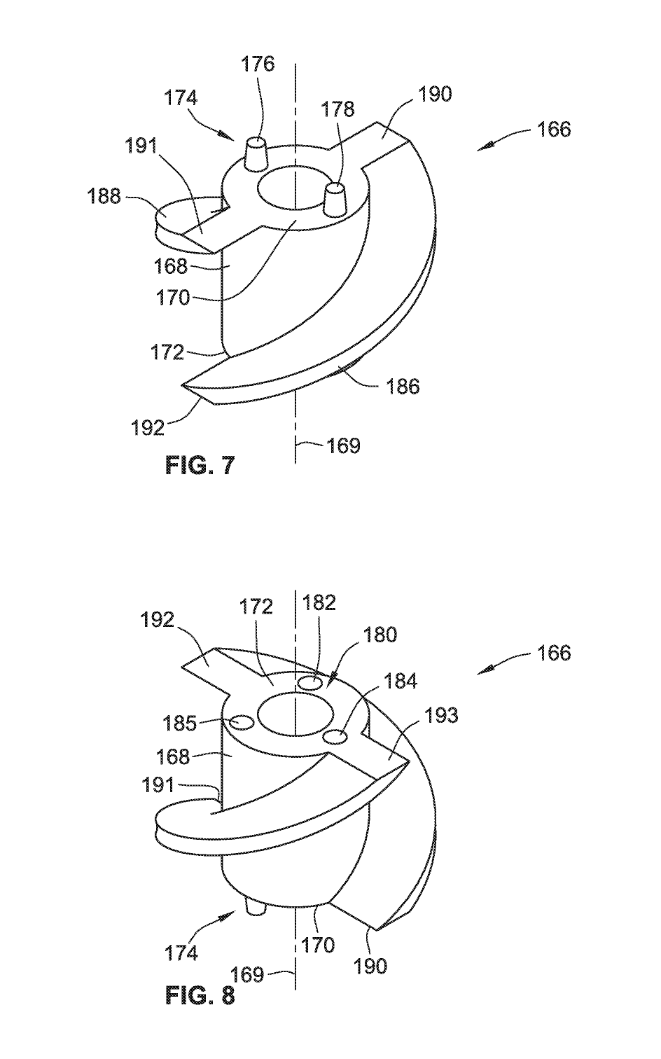

FIGS. 7 and 8 illustrate a first static mixer element 166. The static mixer element 166 includes a core 168, which is a hollow core in this embodiment, that extends axially along a central axis 169 between a first end 170 and a second end 172. The hollow core allows for the shut-off pin to extend through the assembled static mixer 144. The static mixer element 166 includes a first keying feature 174 illustrated in the form of a pair of axially extending projections 176, 178 extending from the second end 172 of core 168 generally parallel to axis 169. In this embodiment, the projections 176, 178 are generally frustoconical to facilitate mating with keying features of a second static mixer element 167.

The static mixer element 166 includes a second keying feature 180 illustrated in the form of a pair of axially extending receiving pockets 182, 184, 185 that extend axially into the first end 170 of the core 168 generally parallel to axis 169.

In the illustrated embodiment, the static mixer element 166 includes a pair of blades 186, 188 extending angularly about the core 168 and axis 169 and radially outward from an outer surface of the core. The blades 186, 188 have a first blade end 190, 191 and a second blade end 192, 193 and extend axially along the core 168 from the first end 170 to the second end 172 between the first and second blade ends 190, 191, 192, 193. As such, the blades 186, 188 extend helically about the core 168.

Blade ends 190, 191 at the first end 170 are angularly offset from one another 180 degrees about axis 169 and similarly blade ends 192, 193 are angularly offset from one another 180 degrees about axis 169.

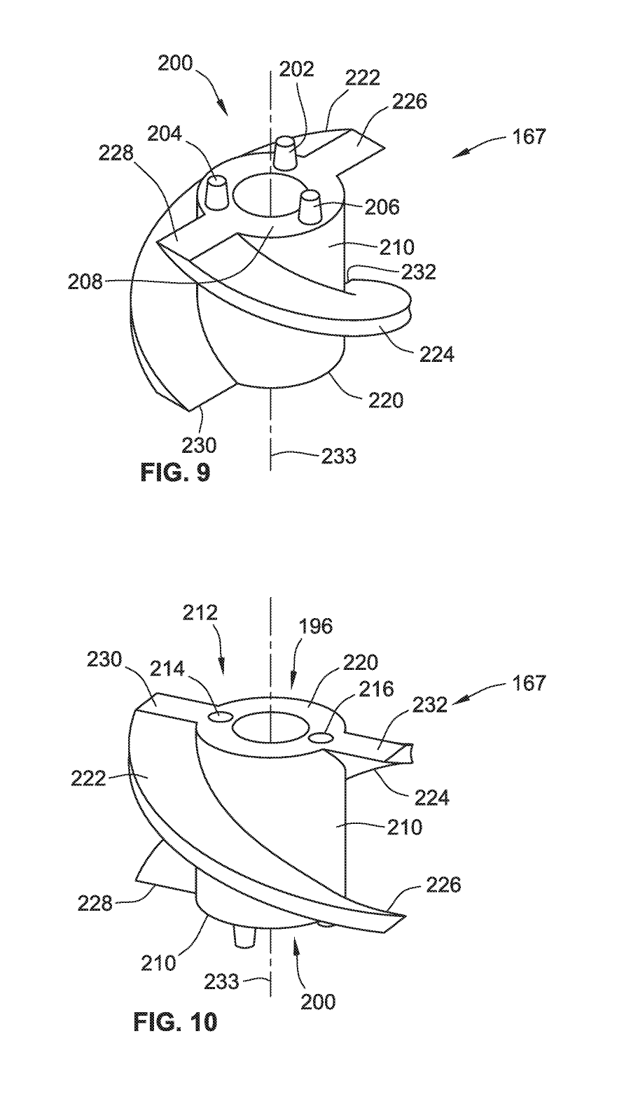

FIGS. 9 and 10 illustrate the second static mixer element 167. This static mixer element 167 is similar to static mixer element 166. However, this static mixer element 176 includes a first keying feature 200 that is configured to mate with the second keying 180 of the first static mixer element 166. The first keying feature 200 is a plurality (three) axially extending projections 202, 204, 206 sized and configured to mate with receiving pockets 182, 184, 185 of the second keying feature 180. These projections are preferably frustoconical and located at a first end 208 of core 210.

The static mixer element 167 includes a second keying feature 212 in the form of a pair of receiving pockets 214, 216 sized and configured to mate with the projections 176, 178 of the first keying feature 174 of the first static mixer element 166. The second keying feature 212 is located at a second end 220 of core 210. The mating sets of keying features (e.g. 174 and 212 as well as 180 and 200) prevent angular rotation of adjacent engaged static mixer elements 166, 167 when stacked to form static mixer 144.

The second static mixer element 167 includes blades 222, 224 similar to blades 186, 188. However, the blades 222, 224 extend radially outward from an outer surface of core 210 and are oriented in an opposite angular direction about core 210 as blades 186, 188 about core 168. Blades 222, 224 extend axially between first blade ends 226, 228 and second blade ends 230, 232. The first blade ends 226, 228 are proximate first end 208 and are angularly spaced apart by 180 degrees about axis 233. The second blade ends 230, 232 are proximate second end 220 and angular spaced apart by 180 degrees about axis 233.

The first and second static mixer elements include hollow cores 168, 210. The hollow opening of the cores 168, 210 align when stacked to form a passage through which a shut-off pin 140 can extend.

In the illustrated embodiment, and with additional reference to FIG. 5, the keying features 174, 180, 200, 212 (see FIGS. 7-10) of adjacent static mixer elements 166, 167 are configured to mate to prevent angular rotation of adjacent static mixer elements 166, 167 when stacked and engaged. Further, the keying features 174, 180, 200, 212 are configured such that the adjacent blade ends of blades of adjacent static mixer elements 166, 167 are angularly offset by 90 degrees. More particularly, the first blade ends 190, 191 of a first static mixer element 166, which are 180 degrees angularly offset from one another, are 90 degrees angularly offset from the second blade ends 230, 232, which are also 180 degrees angularly offset from one another. Similarly, the second blade ends 192, 193 of a first static mixer element 166, which are 180 degrees angularly offset from one another, are 90 degrees angularly offset from the first blade ends 226, 228, which are also 180 degrees angularly offset from one another. As such, blades from adjacent static mixer elements 166, 167 do not connect and form continuous blades but instead are spaced apart forming gaps 240 therebetween.

While different keying features/interfaces are disclosed, e.g. 2 projection/receiver pocket arrangements or 3 projection/receiver pocket arrangements, other embodiments could use the same number of projection/receiver pocket arrangements for each interface.

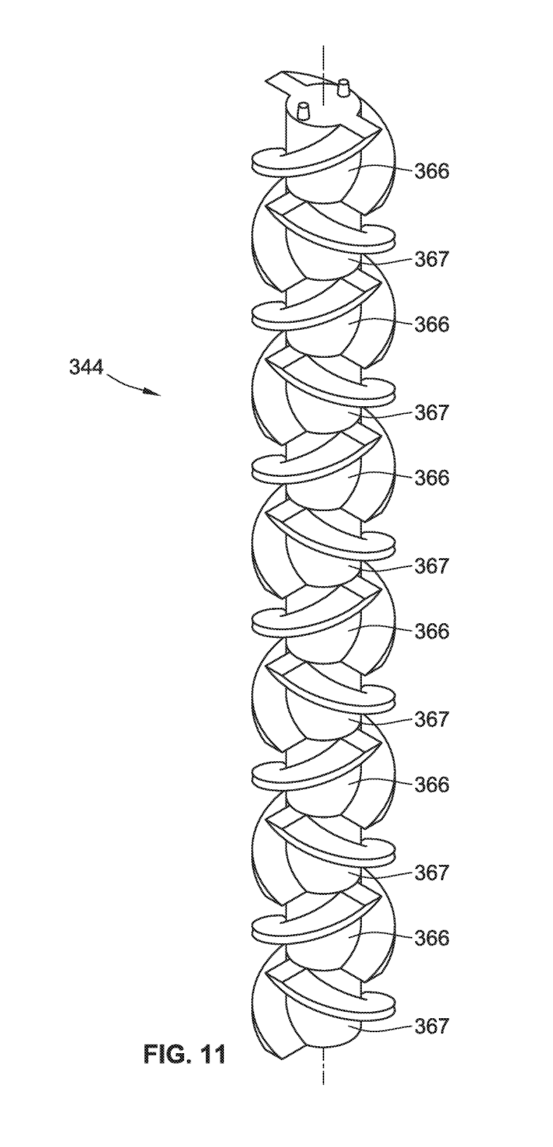

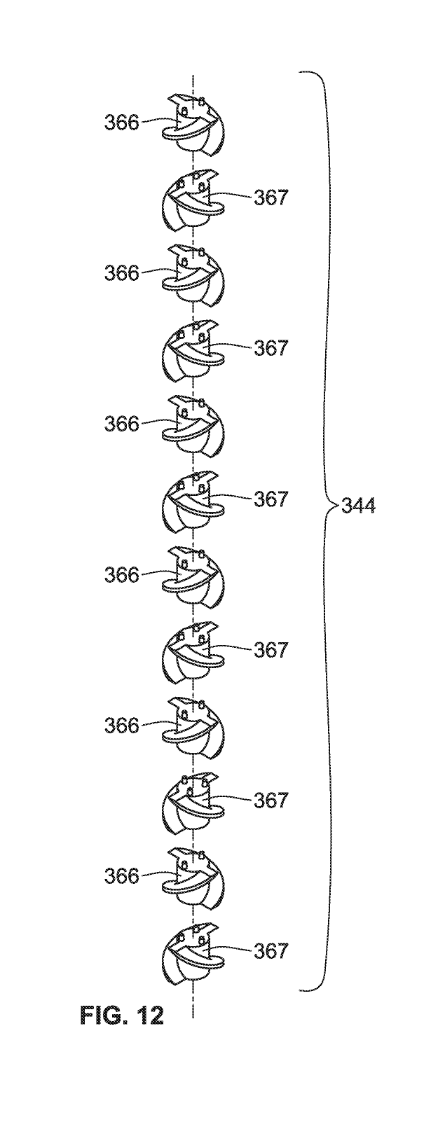

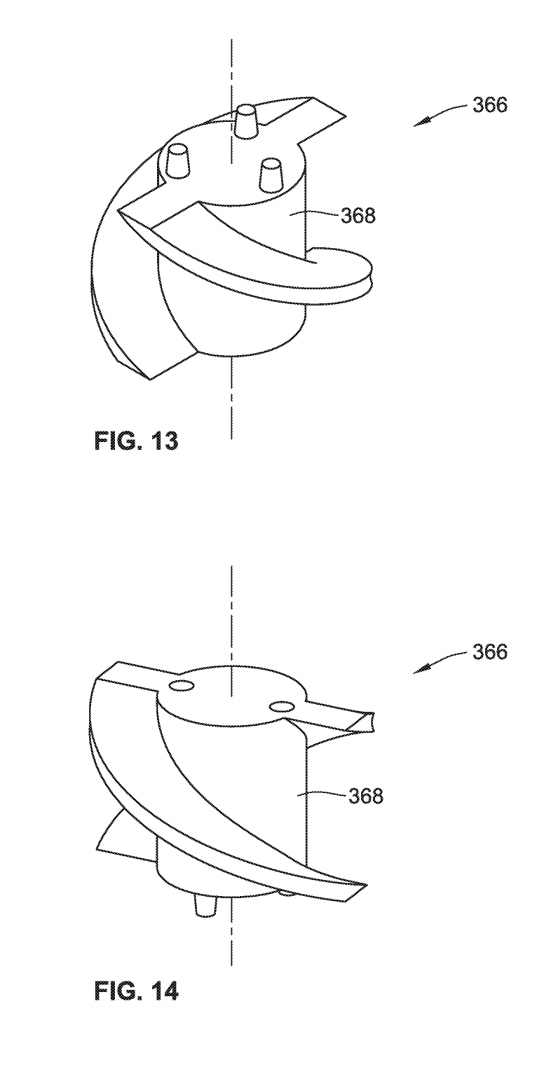

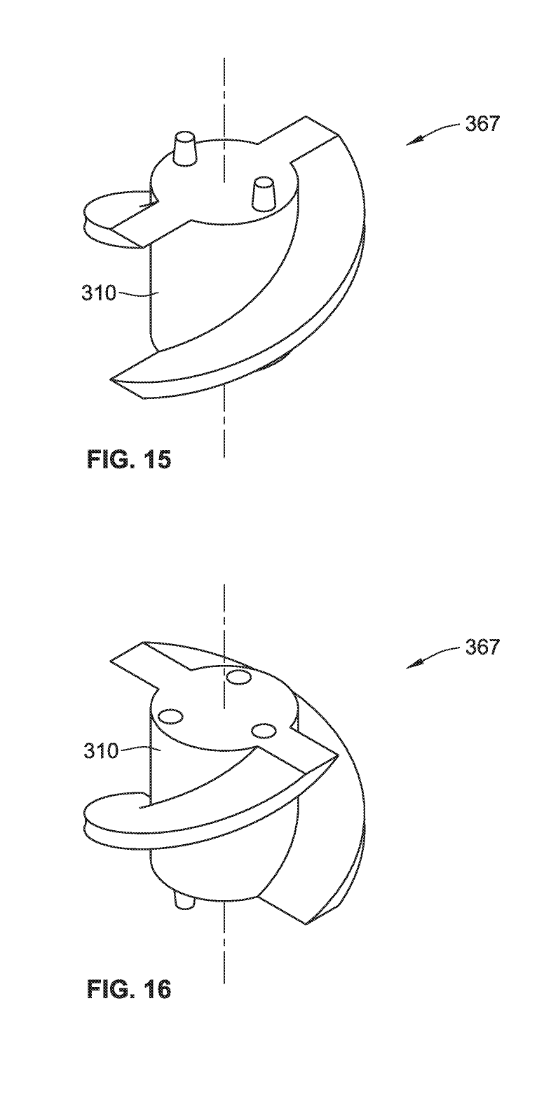

Further, FIGS. 11-16 illustrate a further static mixer 344. This static mixer has substantially all of the features outlined above for static mixer 144. However, in this embodiment, the static mixer elements 366, 367 of the static mixer 144 have solid cores 368, 310. The solid core design provides increased strength and rigidity.

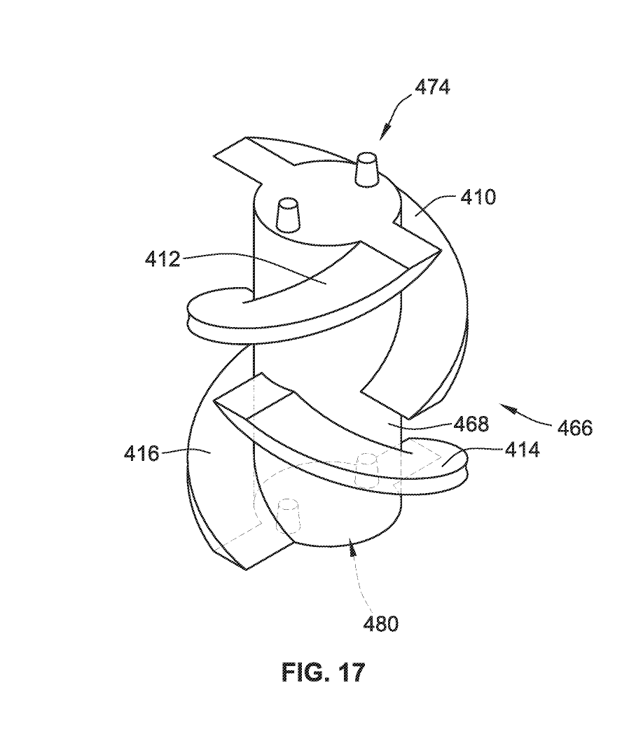

FIG. 17 illustrates a further embodiment of a static mixer element 466. Static mixer element 466 is a single continuous element that has a plurality of blade sections 410, 412, 414, 416 that extend angularly about core 468 180 degrees each, but that do not extend the entire axial length of the core. This static mixer element 466 would have keying features where the first keying feature 474 would mate with the second keying feature 480 (shown in dashed lines) in the opposite end of the core 468. This is because two separate types of mixer elements are not needed in this embodiment because each mixer element 466 has blades that go in both direction angularly about the core 468.

Methods of forming the static mixers disclosed herein are also contemplated. The methods could include forming a plurality of static mixer elements and then assembling a first set to form a static mixer of a first length and then assembling a second set to form a static mixer of a second length. The ability to customize the length of a static mixer allows the user to customize amount of time or the length of the flow path based on the material being mixed to make sure that the most efficient amount of mixing is provided for a given set of materials being mixed as well as to prevent unnecessary waste or premature curing of the materials within the static mixer.

Further, a plurality of the static mixer elements could be formed from a same mold. As such, multiple static mixer elements in a single static mixer would be formed from a same mold cavity and then assembled. By using a single mold cavity to form a plurality of the static mixer elements and then assembling them, a complex mold forming duplicative mold cavities is not necessary to have manufactured reducing the cost of the molds.

While the keying features disclosed herein are a predetermined number of projections offset from the central axis of the static mixer elements, other keying features could be provided. For instance, a single non-circular projection and cooperating receiving pocket could be provided that is centered on the rotation axis.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A static mixer comprising:
a plurality of static mixer elements, each static mixer element including a core extending axially along a longitudinal axis between a first end and a second end, each static mixer element including at least one blade around an outside of the core; and
at least a first one of the plurality of static mixer elements including a first keying feature and at least a second one of the plurality of static mixer elements including a second keying feature configured to engage the first keying feature to prevent relative rotation between the first one of the plurality of static mixer elements and the second one of the plurality of static mixer elements about the longitudinal axes of the first one and the second one of the plurality of static mixer elements.

2. The static mixer of claim 1, wherein the first keying feature is provided by at least two projections extending axially parallel to the longitudinal axes of the first one of the plurality of static mixer elements and the second keying features is provided by corresponding at least two receiving pockets extending axially parallel to the longitudinal axes of the second one of the plurality of static mixer elements.

3. The static mixer of claim 2, wherein the at least two projections extend axially from an end of the core of the first one of the plurality of static mixer elements and the at least two receiving pockets extend axially into an end of the core of the second one of the plurality of static mixer elements.

4. The static mixer of claim 1, wherein the core of each static mixer element is hollow to permit receipt of a shut-off pin to extend therethrough.

5. The static mixer of claim 1, wherein the core of each static mixer element is solid.

6. The static mixer of claim 1, wherein:
the first keying feature is provided at the first end of the core of the first one of the plurality of static mixer elements and the second keying feature is provided at the second end of the core of the second one of the plurality of static mixer elements, the first end of the first one of the plurality of static mixer elements is axially adjacent the second end of the second one of the plurality of static mixer elements when the first keying feature is engaged with the second keying feature;
the at least one blade of each static mixer element has a first blade end proximate the first end of the core and a second blade end proximate the second end of the core, the at least one blade of each static mixer element extends helically around the core of the static mixer element between the first and second blade ends; and
the first and second keying features being configured such that the first blade end of the at least one blade of the first one of the plurality of static mixer elements is angularly offset from the second blade end of the at least one blade of the second one of the plurality of static mixer elements such that the blades of the first and second ones of the plurality of static mixer elements due not align to form a continuous blade.

7. The static mixer of claim 6, wherein:
each static mixer element includes at least two blades extending axially along the core and helically around the core;
wherein adjacent blade ends of the first and second ones of the plurality of static mixer elements are angularly offset such that the blade ends of the at least two blades of the first one of the plurality of static mixer elements do not align with the blade ends of the at least two blades of the second one of the plurality of static mixer elements such that the at least two blades of the first and second ones of the plurality of static mixer elements do not form continuous blades.

8. The static mixer of claim 7, wherein:
the first blade ends of the at least two blades of the first one of the plurality of static mixer elements are angularly offset from one another by 180 degrees and the second blade ends of the at least two blades of the second one of the plurality of static mixer elements are angularly offset from one another by 180 degrees; and
the first blade ends of first one of the plurality of static mixer elements are 90 degrees offset from the second blade ends of the second one of the plurality of static mixer elements when the first and second ones of the plurality of static mixer elements are engaged.

9. The static mixer of claim 1, wherein the at least one blade of the first one of the plurality of static mixer elements extends angularly about the core of the first one of the plurality of static mixer elements in a first direction from the first end to the second end and the at least one blade of the second one of the plurality of static mixer elements extends angularly about the core of the second one of the plurality of static mixer elements in a second angular direction from the first end to the second end, the second direction being opposite the first direction.

10. The static mixer of claim 9, wherein the plurality of static mixer elements includes a third one of the plurality of static mixer elements that is substantially identical to the first one of the plurality of static mixer elements and the plurality of static mixer elements includes a fourth one of the plurality of static mixer elements that is substantially identical to the second one of the plurality of static mixer elements, the first, second, third and fourths ones of the plurality of static mixer elements being stacked with the second one of the plurality of static mixer elements between the first and third ones of the plurality of static mixer elements and with the third one of the plurality of static mixer elements between the second and fourth ones of the plurality of static mixer elements.

11. A method of forming a static mixer comprising:
producing a plurality of static mixer elements, each static mixer element including a core extending axially along a longitudinal axis between a first end and a second end, each static mixer element including at least one blade around an outside of the core;
wherein at least a first one of the plurality of static mixer elements includes a first keying feature and at least a second one of the plurality of static mixer elements includes a second keying feature; and
engaging the first and second keying features to prevent relative rotation between the first one of the plurality of static mixer elements and the second one of the plurality of static mixer elements about the longitudinal axes of the first one and the second one of the plurality of static mixer elements.

12. The method of claim 11, wherein the first keying feature is provided by at least two projections extending axially parallel to the longitudinal axes of the first one of the plurality of static mixer elements and the second keying features is provided by corresponding at least two receiving pockets extending axially parallel to the longitudinal axes of the second one of the plurality of static mixer elements.

13. The method of claim 12, wherein the at least two projections extend axially from an end of the core of the first one of the plurality of static mixer elements and the at least two receiving pockets extend axially into an end of the core of the second one of the plurality of static mixer elements.

14. The method of claim 11, wherein the core of each static mixer element is hollow to permit receipt of a shut-off pin to extend therethrough.

15. The method of claim 11, wherein the core of each static mixer element is solid.

16. The method of claim 11, wherein:
the first keying feature is provided at the first end of the core of the first one of the plurality of static mixer elements and the second keying feature is provided at the second end of the core of the second one of the plurality of static mixer elements, the first end of the first one of the plurality of static mixer elements is axially adjacent the second end of the second one of the plurality of static mixer elements when the first keying feature is engaged with the second keying feature;
the at least one blade of each static mixer element has a first blade end proximate the first end of the core and a second blade end proximate the second end of the core, the at least one blade of each static mixer element extends helically around the core of the static mixer element between the first and second blade ends; and
the first and second keying features being configured such that the first blade end of the at least one blade of the first one of the plurality of static mixer elements is angularly offset from the second blade end of the at least one blade of the second one of the plurality of static mixer elements such that the blades of the first and second ones of the plurality of static mixer elements due not align to form a continuous blade.

17. The method of claim 16, wherein:
each static mixer element includes at least two blades extending axially along the core and helically around the core;
wherein adjacent blade ends of the first and second ones of the plurality of static mixer elements are angularly offset such that the blade ends of the at least two blades of the first one of the plurality of static mixer elements do not align with the blade ends of the at least two blades of the second one of the plurality of static mixer elements such that the at least two blades of the first and second ones of the plurality of static mixer elements do not form continuous blades.

18. The method of claim 17, wherein:
the first blade ends of the at least two blades of the first one of the plurality of static mixer elements are angularly offset from one another by 180 degrees and the second blade ends of the at least two blades of the second one of the plurality of static mixer elements are angularly offset from one another by 180 degrees; and
the first blade ends of first one of the plurality of static mixer elements are 90 degrees offset from the second blade ends of the second one of the plurality of static mixer elements when the first and second ones of the plurality of static mixer elements are engaged.

19. The method of claim 11, wherein the at least one blade of the first one of the plurality of static mixer elements extends angularly about the core of the first one of the plurality of static mixer elements in a first direction from the first end to the second end and the at least one blade of the second one of the plurality of static mixer elements extends angularly about the core of the second one of the plurality of static mixer elements in a second angular direction from the first end to the second end, the second direction being opposite the first direction.

20. The method of claim 19, wherein a third one of the plurality of static mixer elements is substantially identical to the first one of the plurality of static mixer elements and a fourth one of the plurality of static mixer elements is substantially identical to the second one of the plurality of static mixer elements, the first, second, third and fourths ones of the plurality of static mixer elements being stacked with the second one of the plurality of static mixer elements between the first and third ones of the plurality of static mixer elements and with the third one of the plurality of static mixer elements between the second and fourth ones of the plurality of static mixer elements.
